(19) United States
(12) Patent Application Publication
(10) Pub. No.: US 2010/0018238 A1
(43) Pub. Date: Jan. 28, 2010

(54) WATER FILTER UNIT

(75) Inventors: Jûrgen Gerner, Schwendi (DE); Heinz Rother, Laupheim (DE)

Correspondence Address: DILWORTH & BARRESE, LLP, 1000 WOODBURY ROAD, SUITE 405, WOODBURY, NY, 11797, US

(73) Assignee: LIEBHERR-HAUSGERATE OCHSENHAUSEN GMBH, Ochsenhausen (DE)

(21) Appl. No.: 12/508,087

(22) Filed: Jul. 23, 2009

(30) Foreign Application Priority Data
Jul. 24, 2008 (DE) UM 202008009953.6
Sep. 18, 2008 (DE) UM 202008012412.3

(51) Int. Cl. F25D 17/02; B01D 35/30

(52) U.S. Cl. 62/318; 210/232; 210/236

(57) ABSTRACT

The present invention relates to a water filter unit for a refrigerator and/or freezer, wherein the water filter unit includes at least one base body and at least one receptacle for a filter cartridge, which is movable relative to the base body.

The present invention relates to a water filter unit for a refrigerator and/or freezer.

From the prior art, refrigerators and/or freezers are known, which include an ice cube maker. For the purpose of cleaning the water supplied to the ice cube maker, it is furthermore known to provide a water filter between the water inlet of the appliance and the ice cube maker. After passing through the water filter, the cleaned water gets into the ice cube maker.

Such known water filters comprise a so-called filter cartridge, in which the water is filtered. This filter cartridge usually is mounted inside the cooling part container directly on a receptacle with a filter head, e.g. on the inside of the rear wall of the container. Such arrangement known from the prior art is shown in FIG. 8. Here, reference numeral 300 designates a filter cartridge, which is screwed into a receptacle 400, which—as shown—is located in the vicinity of the rear wall of the container. If the filter cartridge 300 must be replaced, the same is removed from the receptacle 400 by a rotary movement and replaced by a new filter cartridge.

It is the object underlying the present invention to develop a water filter unit as mentioned above in an advantageous way.

This object is solved by a water filter unit with the features of claim 1. Accordingly, it is provided that the water filter unit includes at least one base body and at least one receptacle for the filter cartridge, which is movable relative to the base body. In accordance with the invention, it thus is provided that the water filter unit consists of at least two parts movable relative to each other, whereby replacement of the filter cartridge is facilitated.

Preferably, the water filter unit is formed by a compact filter unit with an integrated receptacle for the filter cartridge, which can universally be employed in various types of appliance inside or also outside the container for refrigerated products.

It is conceivable that the base body includes at least one guideway, by means of which the receptacle for the filter cartridge is movable relative to the base body. If the filter cartridge must be replaced, the receptacle thus can be shifted into a position favorable for the user. Subsequently, the receptacle can again be shifted back into its rest or operating position. The invention comprises any relative movement between base body and receptacle, such as a linear movement or a swivel movement.

It is conceivable that the water filter unit includes at least one filter head, in which the filter cartridge can be inserted. It is conceivable that the filter head as well as the filter cartridge are configured such that inserting the filter cartridge in the filter head or removing the filter cartridge from the filter head is effected by a rotary movement. It is of course also possible to effect insertion and removal of the filter cartridge by a linear movement, for instance by simply plugging in and out.

In a further aspect of the invention it is provided that the water filter unit includes at least one cover for covering the receptacle. In this case, a preferably closed housing is provided, which offers good protection against soiling.

Furthermore, it can be provided that the water filter unit includes at least one lid, through which the water filter unit, in particular the filter head or the opening for receiving the filter cartridge, can be closed in the non-inserted condition of the filter cartridge. Thus, it is conceivable that the lid closes the water filter unit when the filter cartridge is not inserted. Preferably, the lid is dimensioned such that it can be plugged onto the filter cartridge, which involves the advantage that the lid always is located close to the filter cartridge. The lid can for instance serve as an inscription space or as an adhesive surface for a sticker, which shows an information for the next filter replacement to be made.

In a further aspect of the invention it is provided that the water filter unit includes at least one water inlet and at least one water outlet, wherein a tube extends from the water inlet to the filter cartridge or to a component connected with the filter cartridge in the inserted condition of the filter cartridge and/or wherein a tube extends from the filter cartridge or from said component to the water outlet and wherein the tube length is dimensioned such that the receptacle is movable relative to the base body of the water filter unit from an operating position into a removal position, in which the filter cartridge can be removed. In this case, the connection between the water inlet or outlet of the water filter unit and the filter cartridge or a component connected with the same is realized by one or more tubes. The tubes preferably are designed or installed such that said relative movement between receptacle and base body is possible. Preferably, the tubes are installed such that during the relative movement no kinking of the tubes and no particular load will occur in the vicinity of the points of connection of the tubes to the components with which the tubes are connected.

Preferably, it is provided that the tube or the tubes extend in at least one loop to provide for said relative movement between base body and receptacle.

In a further aspect of the invention it is provided that the water inlet and/or the water outlet are arranged on the base body.

Furthermore, it can be provided that the component connected with the filter cartridge is a filter head located in the receptacle.

Preferably it is provided that the base body and the receptacle can be locked relative to each other in one or more positions. Latching or some other locking possibilities are conceivable, for instance, to lock the receptacle in the position in which it is completely withdrawn from the base body or at least to such an extent that filter insertion, removal or replacement of the filter is possible. Alternatively or in addition it can be provided that the receptacle is locked or latched relative to the base body also in its inserted position.

The present invention furthermore relates to a refrigerator and/or freezer which is characterized in that the water filter unit, which is connected with the refrigerator and/or freezer or is mounted on the same, is disposed outside the cooled space of the appliance. In this case, the water filter unit is not located in the cooling part, as known so far, but can be disposed at any position outside the appliance, for instance in a furniture niche or in the base region of the refrigerator below the refrigerator or also at some other point. The water filter unit thus can be used universally with any types of appliance and at any point.

Thus, a particular adaptation of the water filter unit to the special characteristics of the appliance is not necessary.

The present invention furthermore relates to a refrigerator and/or freezer, which includes at least one water filter unit according to any of claims 1 to 10 or is connected with at least one such water filter unit.

In this case, too, it can be provided that the water filter unit is located outside the cooled space. In principle, it is of course also conceivable that the water filter unit is disposed inside the cooled space, in particular inside a cooling compartment of the appliance.

In a further aspect of the invention it is provided that the water filter unit is located in the base region of the refrigerator and/or freezer.

The present invention finally relates to an arrangement with at least one refrigerator and/or freezer according to any of claims 11 to 14, which is characterized in that the arrangement includes at least one piece of furniture, for instance a cupboard, and that the water filter unit is arranged at the piece of furniture.

Further details and advantages of the invention will be explained in detail with reference to an embodiment illustrated in the drawing, in which:

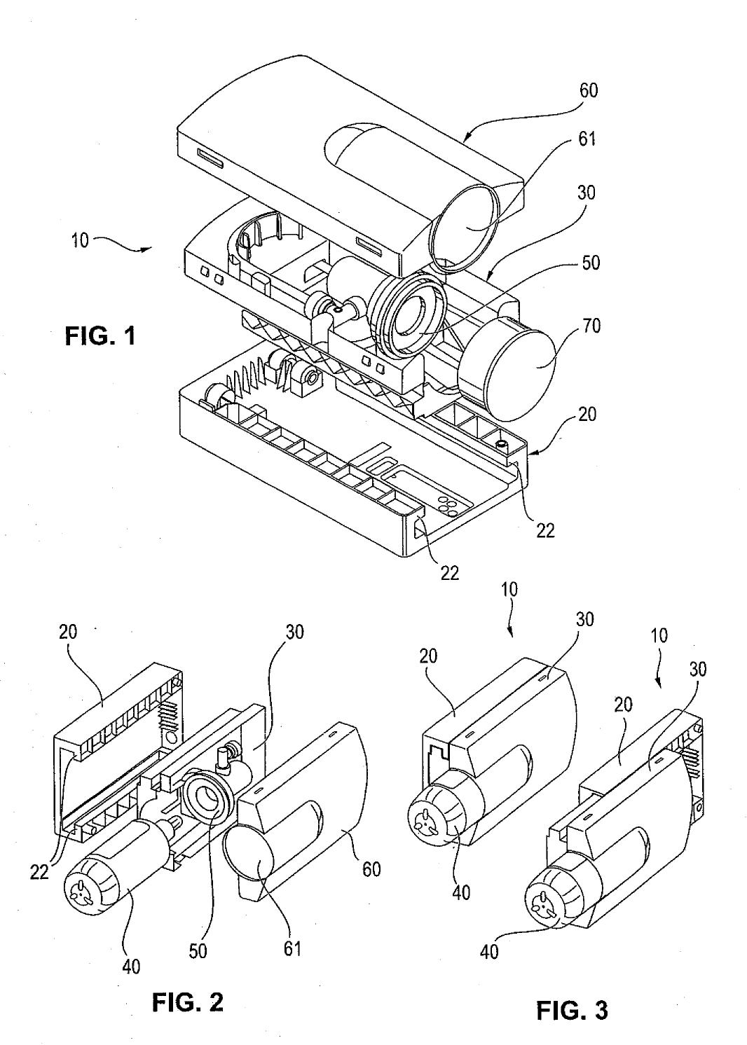

FIG. 1: shows a perspective view of the water filter unit in accordance with the present invention in the exploded condition without filter cartridge,

FIG. 2: shows a further perspective view of the water filter unit in accordance with the present invention in the exploded condition with filter cartridge,

FIG. 3: shows perspective views of the water filter unit in accordance with the present invention in the retracted and extended conditions of the receptacle,

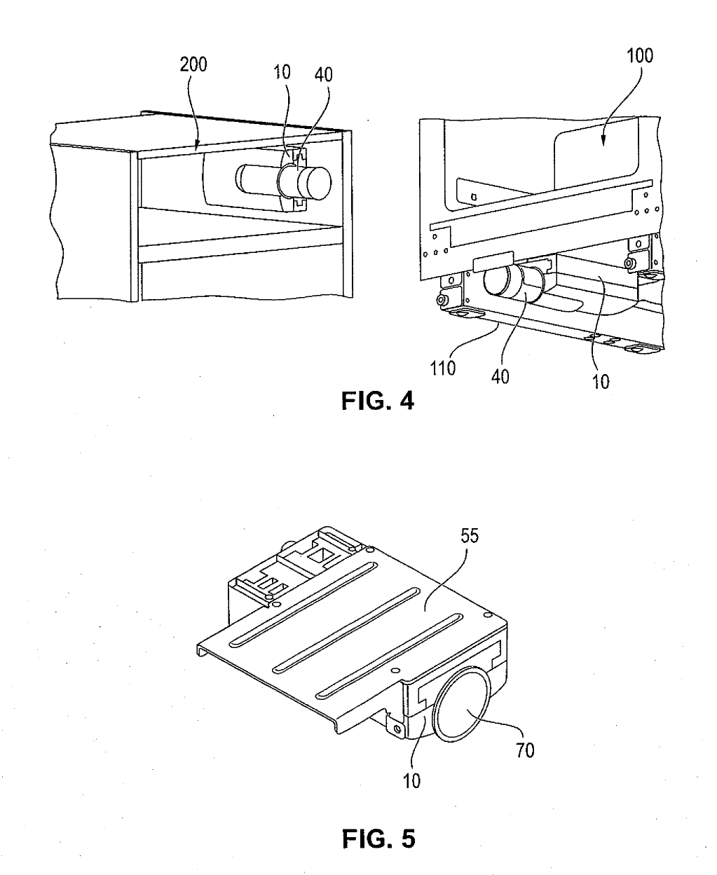

FIG. 4: shows perspective representations of the water filter unit in accordance with the present invention in a condition mounted on a piece of furniture (left-hand representation) and in a condition mounted in the base region of a refrigerator and/or freezer (right-hand representation),

FIG. 5: shows a perspective view of the water filter unit in accordance with the present invention in a condition mounted on a retaining plate,

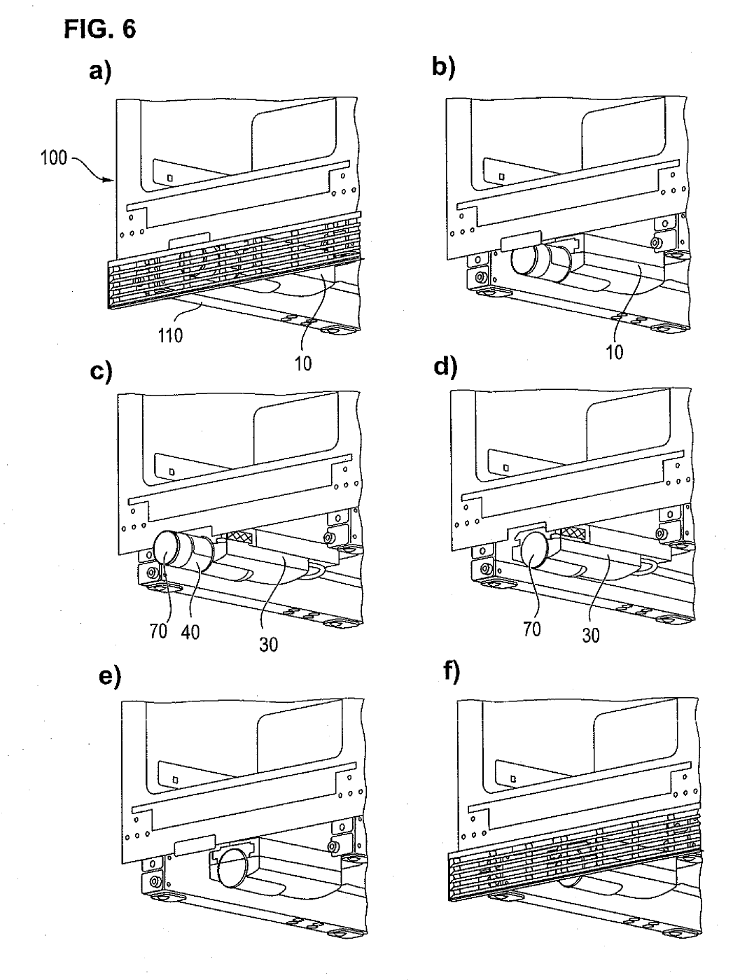

FIG. 6: shows a schematic representation of the steps provided for removing a filter cartridge from the water filter unit in accordance with the present invention,

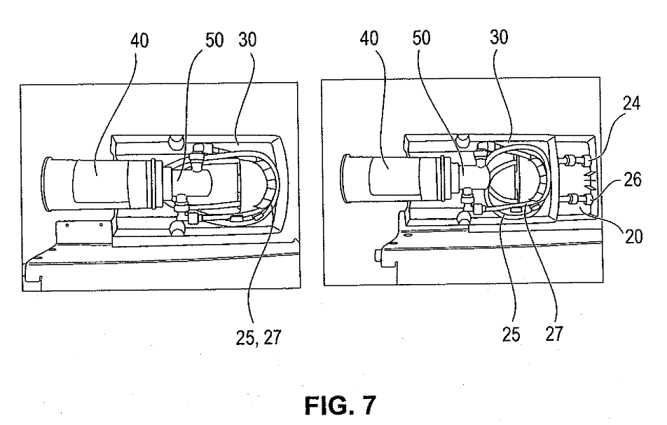

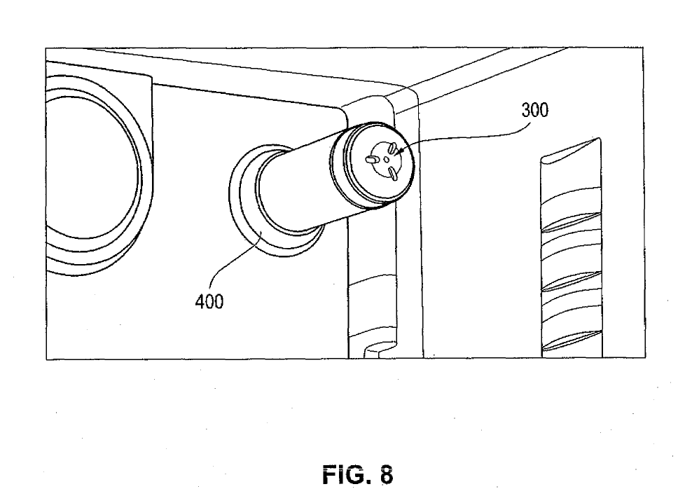

FIG. 7: shows a top view of the water filter unit without cover in accordance with the present invention in the rest position (left-hand representation) and in the removal position (right-hand representation), and

FIG. 8: shows a perspective representation of a filter cartridge in the mounted condition in accordance with the prior art, in the interior of the appliance.

One embodiment of the water filter unit 10 in accordance with the present invention is shown in FIG. 1. Reference numeral 20 designates the base body, which for instance is firmly mounted on a refrigerator and/or freezer or also at some other point, for instance on a piece of furniture. The base body 20 includes guideways 22, in which the receptacle 30 for a filter cartridge not shown in FIG. 1 is movably accommodated.

Reference numeral 50 designates a filter head, which serves to accommodate the end region of the filter cartridge. The filter head 50 is plugged onto the receptacle 30. The receptacle 30 is inserted in the guideway 22 of the base body 20.

By means of latching geometries it can be provided that the receptacle 30 is held either in a rest position or first end position or in a removal position or second end position.

Reference numeral 60 designates a cover which prevents soiling of the water filter unit 10. The cover 60 is dimensioned such that it substantially has the same size as the receptacle 30. Furthermore, the receptacle 30 is dimensioned substantially identical to the base body 20, so that at least in the rest position, i.e. when no filter replacement is intended, a compact unit is obtained, as it is shown in FIG. 3, left-hand representation.

Reference numeral 70 designates a lid which can be plugged onto the filter head 50 or also into an opening 61 of the cover 60 and in this way likewise prevents soiling of the unit when no filter cartridge is inserted. The filter cartridge is inserted through the opening 61, as can be taken from FIG. 3.

FIG. 2 shows the arrangement of FIG. 1 with a filter cartridge 40.

FIG. 3 shows the water filter unit 10 in two different conditions. As shown in FIG. 3, left-hand picture, the receptacle 30 is pushed back and in this condition is in alignment with the outer walls of the base body 20. If the filter cartridge 40 must be replaced, it can be provided to shift the receptacle 30 relative to the base body 20 into a position favorable for the user, as shown in FIG. 3, right-hand representation. Such shifting is made possible by the guideways 22 of the base body 20, in which the receptacle 30 moves.

As explained above, it can be provided that the water filter unit 10 is not located in the cooling space of the appliance, but is arranged outside of the same. FIG. 4, left-hand representation, shows a piece of furniture 200, which preferably can be arranged in the vicinity of a refrigerator and/or freezer or in which the refrigerator and/or freezer is arranged. On a side wall of the piece of furniture 200, the water filter unit 10 is arranged. It can for instance be screwed thereto or be fastened thereto by some other joining technique. The piece of furniture 200 can for instance be a tall cupboard.

As can be taken from FIG. 4, right-hand representation, it can also be provided that the water filter unit 10 is disposed in the base region of a refrigerator and/or freezer 100, which is designated with the reference numeral 110. In this case, the water filter unit 10 thus is located below the refrigerator and/or freezer. In principle, it is likewise conceivable to arrange the water filter unit 10 elsewhere on the appliance 100, for instance on the top side or rear side or on one of the side walls of the appliance. The arrangement of the water filter unit 10 outside the cooled space provides for using the water filter unit universally with any types of appliance.

As shown in FIG. 4, the water filter unit 10 can for instance be screwed to a piece of furniture 200 or be connected with the same in some other way. Furthermore, it is conceivable to arrange the water filter unit 10 on a retaining plate, which in FIG. 5 is designated with the reference numeral 55. This retaining plate 55 then can for instance be screwed or otherwise be attached to a roller base of the appliance 100.

FIG. 5 furthermore illustrates the arrangement of the lid 70 in the cover 60 and in the condition in which no filter cartridge 40 is present in the appliance.

FIG. 6 shows the steps performed for replacement of a filter cartridge 40, wherein the water filter unit 10 is located in the region behind a ventilation grid in the base region 110 of a refrigerator and/or freezer 100, as shown in FIG. 6a.

As can be taken from FIGS. 6a and 6b, the ventilation grid first is removed, and then, as shown in FIG. 6c, the receptacle 30 with the filter cartridge 40 is shifted towards the front, i.e. towards the user, so that the filter cartridge 40 is easily accessible for the user. In this condition, the filter cartridge 40, or at least its end region, protrudes beyond the front side of the appliance 100, so that it can easily be grasped by a user.

In the embodiment shown here, removal of the filter cartridge 40 is effected via an anticlockwise rotary movement in an angle of about 100°. When the cartridge 40 is replaced, the new filter cartridge is again screwed in in opposite direction, which is not shown in FIG. 6.

FIG. 6 shows that the lid 70 can be dimensioned such that it can be plugged onto the filter cartridge 40, when the same is in the inserted condition. Thus, the lid 70 can serve as an indicator for the next filter cartridge replacement necessary or for other information. In the condition plugged onto the filter cartridge 40, the lid 70 always is close to the filter cartridge, so that the information present on the lid 70 always can be coordinated to the associated filter cartridge 40.

Upon removal of the filter cartridge 40, the lid 70 is plugged onto the water filter unit or onto a corresponding opening e.g. in the cover 60, whereby the water filter unit 10 is closed, as is shown in FIG. 6d.

Upon removal of the filter cartridge 40, the receptacle 30 is pushed back, as shown in FIG. 6e, and the ventilation grid is mounted again, as shown in FIG. 6f.

As can be taken from FIG. 7, the base body 20 of the water filter unit includes a water inlet 24 for supplying water from a water source, for instance from a water connection, to the water filter unit 10. From this water inlet 24, a tube 25 extends to the filter head 50 and thus supplies the filter unit 40 with the water to be filtered.

From the filter head 50 a further tube 27 extends to the water outlet 26. From the water outlet 26, a non-illustrated conduit leads e.g. to an ice cube maker of the refrigerator and/or freezer.

As can be taken from FIG. 7, the two tubes 25, 27 extend in at least one loop. With this arrangement it is possible that the relative movement between the base body 20 and the receptacle 30 can take place without the tubes 25, 27 being damaged or being loaded excessively and in particular without kinking of the tubes 25, 27. The installation of the tubes 25, 27 in the filter unit thus is designed such that neither in the rest position shown on the left in FIG. 7, in which the receptacle 30 is not shifted relative to the base body, nor in the removal position as shown in FIG. 7, right-hand representation, in which the receptacle 30 is shifted relative to the base body, nor during shifting, damage and in particular kinking of the tubes will occur.

1. A water filter unit (10) for a refrigerator and/or freezer, wherein the water filter unit (10) includes at least one base body (20) and at least one receptacle (30) for a filter cartridge (40), which is movable relative to the base body (20).

2. The water filter unit (10) according to claim 1, wherein the base body (20) includes at least one guideway (22), by which the receptacle (30) for the filter cartridge (40) can be shifted relative to the base body (20).

3. The water filter unit (10) according to claim 1, wherein the water filter unit includes at least one filter head (50) in which the filter cartridge (40) can be inserted.

4. The water filter unit (10) according to claim 3, wherein the filter head (50) and the filter cartridge (40) are configured such that insertion of the filter cartridge (40) in the filter head (50) and/or removal of the filter cartridge (40) from the filter head (50) is effected with a rotary movement.

5. The water filter unit (10) according to claim 1, wherein the water filter unit (10) includes at least one cover (60) for covering the receptacle (30).

6. The water filter unit (10) according to claim 1, wherein the water filter unit (10) includes at least one lid (70) by which the water filter unit (10), in particular the filter head (50) or the cover (60), can be closed in the non-inserted condition of the filter cartridge (40).

7. The water filter unit (10) according to claim 1, wherein the water filter unit (10) includes at least one water inlet (24) and at least one water outlet (26), that a tube (25) extends from the water inlet (24) to the filter cartridge (40) or to a component connected with the filter cartridge (40) in the inserted condition of the filter cartridge (40) and/or that a tube (27) extends from the filter cartridge (40) or from said component to the water outlet (26), and the tube length is dimensioned such that the receptacle (30) can be moved relative to the base body (20) of the water filter unit (10) from a rest position into a removal position in which the filter cartridge (40) can be removed.

8. The water filter unit (10) according to claim 7, wherein the tube or the tubes (25, 27) extend in at least one loop to provide for the relative movement between base body (20) and receptacle (30).

9. The water filter unit (10) according to claim 7, wherein the water inlet (24) and/or the water outlet (26) are arranged on the base body (20).

10. The water filter unit (10) according to claim 7, wherein the component connected with the filter cartridge (40) is a filter head (50) located in the receptacle (30).

11. A refrigerator and/or freezer (100), wherein the refrigerator and/or freezer (100) includes at least one water filter unit (10) and at least one cooled space and the water filter unit (10) is located outside the cooled space.

12. The refrigerator and/or freezer (100), wherein the refrigerator and/or freezer (100) includes or is connected with at least one water filter unit (10) according to claim 1.

13. The refrigerator and/or freezer (100) according to claim 12, wherein the refrigerator and/or freezer (100) includes at least one cooled space and that the water filter unit (10) is located outside the cooled space.

14. The refrigerator and/or freezer (100) according to claim 13, wherein the water filter unit (10) is located in the base region (110) of the refrigerator and/or freezer (100).

15. The refrigerator and/or freezer according to claim 1, wherein the base body (20) and the receptacle movable relative to the base body (20) can be locked, preferably latched relative to each other in one or more preferred positions.

16. An arrangement with at least one refrigerator and/or freezer (100) according to claim 11, wherein the arrangement includes at least one piece of furniture (200) and the water filter unit (10) is arranged on the piece of furniture (200).

17. The water filter unit (10) according to claim 2, wherein the water filter unit includes at least one filter head (50) in which the filter cartridge (40) can be inserted.

18. The water filter unit (10) according to claim 17, wherein the filter head (50) and the filter cartridge (40) are configured such that insertion of the filter cartridge (40) in the filter head (50) and/or removal of the filter cartridge (40) from the filter head (50) is effected with a rotary movement.

19. The water filter unit (10) according to claim 18, wherein the water filter unit (10) includes at least one cover (60) for covering the receptacle (30).

20. The water filter unit (10) according to claim 17, wherein the water filter unit (10) includes at least one cover (60) for covering the receptacle (30).
